(19) United States
(12) Patent Application Publication
(10) Pub. No.: US 2005/0283683 A1
(43) Pub. Date: Dec. 22, 2005

(54) System and method for promoting effective operation in user computers

(75) Inventors: Scott Sina Abedi, Durham, NC (US); Daryl Carvis Cromer, Apex, NC (US); Brian Woodall Killebrew, Raleigh, NC (US); Joseph Nicholas Laltrello, Chapel Hill, NC (US); Alan Ladd Painter, Raleigh, NC (US); James Stephen Rutledge, Durham, NC (US); Tin-Lup Wong, Chapel Hill, NC (US)

Correspondence Address: LENOVO (SINGAPORE) PTE. LTD., BUILDING 675, MAIL C-137, 4401 SILICON DRIVE, DURHAM, NC, 27709, US

(73) Assignee: International Business Machines Corporation, Armonk, NY (US)

(21) Appl. No.: 10/863,107

(22) Filed: Jun. 8, 2004

(51) Int. Cl. G06F 11/00

(52) U.S. Cl. 714/43

(57) ABSTRACT

Operating parameters and potentially related malfunctions are gathered from end users of computer systems and used to develop a best practices profile. The profile can be used to automatically alter the operating parameters of a user computer.

### FIELD OF THE INVENTION

The present invention relates generally to optimizing the operating procedures of user computers.

### BACKGROUND

From time to time end user computer system components can malfunction at rates higher than expected. Typically, the malfunctions are observed in the beginning by information technology (IT) personnel who are tasked with fixing a user's computer. Unfortunately, the IT personnel tasked with maintenance at the unit level do not recognize the root causes of problems (e.g., excessive heating, excessive power on time, etc.) much less are they equipped with information from a sufficiently large base of user system repairs to correlate root causes with potentially deleterious operating practices. Thus, there is no reliable way to systematically anticipate future similar malfunctions in other end user systems, much less to suggest to users how to modify their operating practices to reduce the likelihood of equipment malfunction. Instead, IT personnel more or less must behave reactively in responding to malfunctions as they occur, instead of proactively identifying potential problems preemptively and advising users how they might prolong the useful life of a component or system. This invention is addressed to the above noted problem.

### SUMMARY OF THE INVENTION

A method includes establishing, using information from plural user computers of a given type, a best practices profile. One or more operating parameters of a user computer of the given type are then adjusted to conform to the best practices profile.

In a preferred implementation, the method can include receiving operating parameters from plural first user computers and using the data and information regarding malfunctions, if any, of the first user computers, to establish the best practices profile. Then, the best practices profile can be compared to operating parameters of a second user computer, and operating parameters at the second user computer can be automatically changed based on the comparison.

The operating parameter can be selected from the group of parameters consisting of: temperature, hours of operation, number of on-off cycles, power consumption, humidity, voltage, and application factors such as screen saver use.

In another aspect, a general purpose computer system executes logic that includes receiving first data representing computer system operating parameters and associated computer system malfunctions, and generating a best practices profile based on the first data. The logic can also include altering the operating parameters of a user computer system based on comparing the operating parameters to the best practices profile.

In yet another aspect, a service includes providing, to a customer, a model profile of a user computer type based at least in part on correlating operating parameters with malfunctions from plural user computers of the user computer type.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present architecture; and

FIG. 2 is a flow chart of the present method.

### DETAILED DESCRIPTION OF THE PREFERRED EMBODIMENT

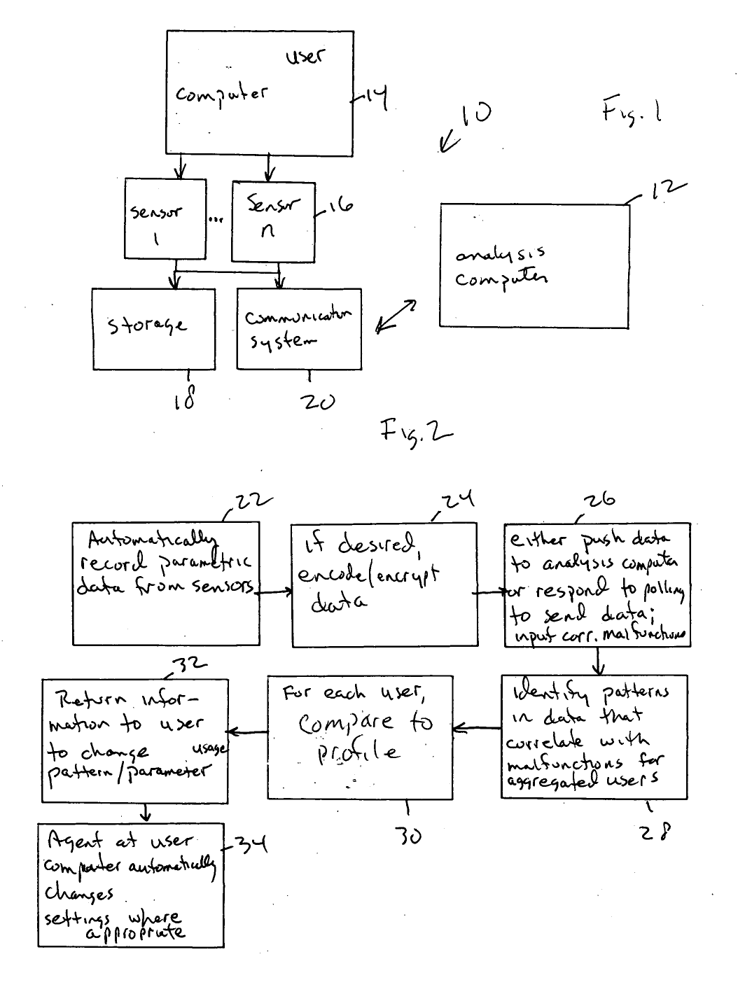

Referring initially to FIG. 1, a computing system is shown, generally designated 10, that includes one or more analysis computers 12 (only a single computer 12 shown for clarity) that undertakes the modelling set forth further below based on input from plural user computers 14 (only a single customer computer shown for clarity). The computers herein can be any suitable computers, e.g., a personal computer or larger (mainframe), a laptop computer, a notebook computer or smaller, etc. For instance, the user computers 14 without limitation can be an IBM Thinkpad® or ThinkCentre™ computer. The analysis computer 12 can be provided by a service provider or it can be provided to a customer with several individual user computers 14. The below-described functions of the analysis computer 12 can be distributed between a vendor server and a customer server if desired.

As shown in FIG. 1, each user computer 14 may include plural sensors 16 that sense operating parameters of the user computer 14. These operating parameters can include environmental characteristics such as computer component temperatures (average and/or peak), airflow, humidity within the user computer 14 components and/or facility, etc. The operating parameters can also include usage patterns, such as the total hours of operation of one or more system components since, e.g., a component was placed into service, number of on-off cycles of one or more system components, power consumption of one or more components, both average and, if desired, peak power consumption, and voltages of computer system components, both average and if desired fluctuations. Also, the operating parameters can include application factors such as whether and what type of a screen saver might be invoked. Accordingly, the sensors 16 may include, without limitation, power sensors, voltage sensors, temperature sensors, humidity sensors, air flow sensors, application records, and timers, and they can be mounted on circuit boards with, e.g., the central processing unit of the user computer 14, within a hard disk drive of the user computer 14, within the power circuit of the user computer 14, and/or on other peripheral computer system components such as monitors, printers, etc.

The user computer 14 may also include storage 18 for storing the outputs of the sensor 16. Also, the user computer 14 can include a communication system 20 such as, without limitation, a modem that can communicate over a network such as the Internet with the analysis computer 12. With this structure, it may be appreciated that the operating parameter data output by the sensors 16 can be stored in the storage 18 for retrieval by personnel associated with the analysis computer 12, and/or it can be sent to the analysis computer 12 over the Internet.

Now referring to FIG. 2, commencing at block 22 the operating parameter data from the sensors 16 of preferably plural user computers 14 of the same type or genera is recorded. Also, information regarding malfunctions, if any, in the systems 14 that generate the parametric data is recorded. For instance, hard disk drive failure incidents may be noted. Moving to block 24, the parametric data and associated malfunction information can be encoded and encrypted if desired for transmission to the analysis computer 12 over the Internet. Or, the information can be prepared for transmission on a “sideband” channel such as a so-called DataFlight Recorder and LAN subsystem using ASF or other schema for security.

Proceeding to block 26, the information from the user computers is pushed by the user computers automatically at, e.g., predetermined intervals to the analysis computer 12, or the analysis computer 12 can poll the user computers for their information, which they then send to the analysis computer 12. Any malfunctions are correlated with the information from the user computers.

At block 28, patterns in the operating parameter information as they relate to malfunctions are noted and used to generate a best practice profile for the particular type of user computer. More specifically, a malfunction of a particular user computer 14 is associated with the relevant parametric data from that computer system. The best practices profile can be generated using modelling principles known in the art. For example, regression analysis can be used to identify a particular operating parameter value that is correlated with the malfunctions. The analysis to generate the model can be done manually or using neural networks that employ model generation algorithms. In one example, it might happen that a higher than usual number of disk drive failures are discovered to occur at internal disk drive average temperatures exceeding a threshold for a particular period of time. The resulting model in such a circumstance would be to generate a profile that causes increased cooling fan speed to be implemented for user systems wherein the relevant temperature exceeds the threshold. Or, it might be noted that computers operated at temperatures below a threshold experience fewer than expected malfunctions. The best practices profile accordingly would indicate operating at temperatures below the threshold.

As another example, it might be observed that a higher than usual number of CPU failures are discovered to occur when average power consumption exceeds a threshold and when the rate of on-off cycles exceeds a threshold. The resulting model in such a circumstance would be to generate a profile in which power cycle rates and average power consumption are maintained below the respective thresholds. As yet another example, it might be noted that certain software failures occur when 3-D screen savers are used. In this case, the best practices profile would indicate that the use of 3-D screen savers be avoided for the particular computer type being profiled. The examples above are of course illustrative only.

Once the best practices profile has been generated, the logic can move to block 30 to compare operating parameters of a particular user computer of the relevant type to the profile. At block 32 information is returned to the user computer to automatically cause the user computer to alter one or more operating parameters, including usage patterns. This automatic reconfiguration of operating parameters can be executed at block 34 by an agent software program in the user computer, which aligns the computer's operating parameters with the best practices profile by, e.g., terminating use of 3-D screen savers, increasing cooling fan speed to reduce temperature, etc. Or, the information itself can be a command from a server, such as the analysis server 12 or a customer's server that communicates with the analysis server 12, that causes the user computer to reconfigure one or more operating parameters.

The above can be provided as a service. For instance, the profile can be generated and returned to a customer server, which can then use the profile to establish operating parameters of various customer user computers. Yet again, the profile need not be provided to the customer, but instead used by a vendor server to automatically reconfigure, over the Internet for instance, a customer's user computers.

While the particular SYSTEM AND METHOD FOR PROMOTING EFFECTIVE OPERATION IN USER COMPUTERS as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconcilable with the present specification and file history.

1. A method comprising:
establishing, using information from plural user computers of a given type, a best practices profile; and
adjusting at least one operating parameter of a user computer of the given type to conform to the best practices profile.

2. The method of claim 1, comprising:
receiving data from plural first user computers, the data representing at least one operating parameter of at least a portion of the first user computers;
using the data and information regarding malfunctions, if any, of the first user computers, establishing the best practices profile;
comparing the best practices profile to operating parameters of a second user computer; and
automatically changing at least one operating parameter at the second user computer based on the comparing act.

3. The method of claim 2, wherein the operating parameter is selected from the group of parameters consisting of: temperature, hours of operation, number of on-off cycles, power consumption, humidity, voltage, and application factors.

4. The method of claim 3, wherein the application factors include screen saver use.

5. A general purpose computer system executing logic comprising:
receiving first data representing at least one computer system operating parameter and associated computer system malfunction;
generating at least one best practices profile based on the first data; and
altering at least one operating parameter of a user computer system based on comparing the operating parameter to the best practices profile.

6. The system of claim 5, wherein the operating parameter is selected from the group of parameters consisting of: temperature, hours of operation, number of on-off cycles, power consumption, humidity, voltage, and application factors.

7. The system of claim 6, wherein the altering act is undertaken automatically by a server communicating with the user computer.

8. The system of claim 6, wherein the altering act is undertaken automatically by the user computer.

9. A general purpose computer system comprising:
means for receiving first data representing at least one computer system operating parameter and associated computer system malfunction;
means for generating at least one best practices profile based on the first data; and
means for altering at least one operating parameter of a user computer system based on comparing the operating parameter to the best practices profile.

10. A service, comprising:
providing, to a customer, a model profile of a user computer type based at least in part on correlating operating parameters with malfunctions from plural user computers of the user computer type.

11. The service of claim 10, comprising automatically altering at least one operating parameter of a user computer of the user computer type based on the model profile.

12. The service of claim 10, comprising providing an agent to the user computer to automatically establish operating parameters thereof based on the model profile.

13. The service of claim 10, wherein the operating parameters are selected from the group of parameters consisting of: temperature, hours of operation, number of on-off cycles, power consumption, humidity, voltage, and application factors.
